(19) United States
(12) Patent Application Publication
(10) Pub. No.: US 2010/0068347 A1
(43) Pub. Date: Mar. 18, 2010

(54) NUTRACEUTICAL SWEETENER COMPOSITION

(76) Inventor: Yael Policker, Tenafly, NJ (US)

Correspondence Address: SONNABENDLAW, 600 PROSPECT AVE, BROOKLYN, NY, 11215, US

(21) Appl. No.: 12/502,262

(22) Filed: Jul. 14, 2009

Related U.S. Application Data
(60) Provisional application No. 61/096,874, filed on Sep. 15, 2008.

(51) Int. Cl. A23L 1/22; A23L 1/304; A23L 1/303; A23L 1/308

(52) U.S. Cl. 426/73; 426/548; 426/74; 426/72; 426/648

(57) ABSTRACT

The present invention relates to nutraceutical compositions relating to a new and useful food and drink additive preparations in the form of sweeteners having soluble calcium admixtures.

### REFERENCE TO RELATED APPLICATION

This patent claims priority of U.S. Provisional Patent Application Ser. No. 61/096,874, filed on Sep. 15, 2008 and incorporated herein by reference.

### FIELD OF THE INVENTION

The present invention relates to a nutraceutical composition, and more particularly, to a nutraceutical composition comprising a mixture of calcium salts and sweeteners.

### BACKGROUND OF THE INVENTION

Consumer awareness of “healthy lifestyle” issues, particularly the importance of keeping a healthy body weight and bone health, has been rapidly increasing.

The appearance and market success of new intense sweetener products such as sucralose (for example, available as Splenda brand sweetener from McNeil Nutritionals, LLC) and stevia (for example, available as Truvia brand sweetener from Truvia company) has demonstrated the importance of achieving a natural taste and mouth feel of products in order to gain wide acceptance by customers.

Osteoporosis and low bone mass are major public health threats for about 44 million people in the U.S. aged 50 and older (55% of the population in that age range). In fact one in two women and one in four men over the age of 50 will experience a bone fracture at some point in their lifetime. These numbers are expected to increase even further with the aging population. Women over 50 are at the greatest risk and account for over 75% of all cases of osteoporosis. The direct care expenditures for osteoporotic fractures alone range from $12.2-$17.9 billion each year, measured in 2002 dollars with each hip fracture having total average medical costs of $30,100 to $43,400.

Adequate intake of calcium and vitamin D (Ca+D) is understood for maintaining bone health throughout life. Calcium is known to reduce bone loss and turnover while Vitamin D is critical for calcium absorption in the gastrointestinal tract and is therefore recommended as an adjunct to calcium intake. Several studies have demonstrated that calcium and vitamin D can reduce the risk of fractures. Potential benefits of adequate Ca+D intake in the prevention of digestive system cancer (especially colorectal cancer) has also been recently reported.

Despite universal recognition and growing awareness of the importance of Ca+D intake it has been found that less than 40% of all American women are reaching recommended daily calcium intake levels. This data is of even greater concern given that over 50% of the women surveyed reported use of calcium supplements. Of note, even in the setting of a clinical trial only 50-60% are compliant. The group with the lowest calcium intake relative to their daily requirement were women above 50 who had not been diagnosed with low bone mass density. This group has slightly higher calcium requirements than those under 50 because the ability to efficiently absorb and utilize dietary calcium decreases with age and with declining ovarian estrogen.

Studies show that Calcium intake for most of the population falls well below their daily requirement across all age groups, from puberty to old age. As a result of this low overall intake and the apparent need to add calcium supplementation, the identification of underlying factors contributing to low adherence to calcium intake and methods for overcoming adherence barriers have been areas of active research. Several significant obstacles were identified for educators and health professionals attempting to enhance calcium intake. For instance, isolated instances of adequate calcium intake could be predicted based on calcium needs but perception of benefits and long-term persistence was predicted in women who did not perceive difficulty in achieving required calcium intake. This result demonstrated the importance of perceived required effort as a barrier to adherence to Ca+D intake.

Food fortification is increasingly recognized as an effective means for delivering micronutrients. Fortification of foods can provide meaningful amounts of a nutrient through normal consumption of the food vehicle. Proper choice of fortification ingredients and processing methods could ensure the stability and bioavailability of the nutrient. It is a goal of this invention to provide an easy and seamless way for enhancing daily intake of Ca+D by fortified sweeteners.

For example, most zero-calorie tabletop sweetener products are using intense sweeteners such as sucralose, saccharin and aspartame that are hundreds of times sweeter than sugar per gram. This means that less than 50mg are required to achieve a sweetness level equal to two teaspoons of sugar (e.g., weighing approximately 10 g). In order to offer easy to use packets of one gram, producers are adding fillers that are typically made of caloric filler ingredients such as dextrose and maltodextrin. These fillers, which typically make up 95% or more of the product, provide no nutritional benefit to consumers (in fact they carry about 4 unwanted calories which still allows the label to say “zero-calorie” according to FDA regulation).

An example of how the required filler can be replaced by an ingredient with desired qualities can be found in the zero-calorie sweetener SplendaFiber™. In this product, some of the filler content has been replaced with soluble fibers.

The prior art discloses admixtures of soluble calcium salt with an intense sweetener to create a sweetener with an added calcium content. The prior art does not disclose an admixture of a sweetener component with a nutritionally effective amount of calcium. For example, a product sold under the brand name “Sucra-Diet” is disclosed to contain 1.2% calcium. Under U.S. Food and Drug Administration regulations, this amount is insufficient to be considered a good source of calcium. Other prior art references disclose sweetener preparation that replace the filler with soluble calcium salt but had a calcium content lower than 10%.

It is also noted manufacturing problems caused by the size of the calcium salt particles and their bulk density have prevented those of skill in the art from producing a viable nutritionally significant admixture of calcium and artificial sweetener. More specifically, when calcium bulk density is too low, dust-like particles of calcium do not properly mix with artificial sweetener components (the calcium particles are said to “hover”). This condition interferes with the proper sealing the sachets of the admixture because the calcium component forms a residue present on the location of the sachet sealing, potentially causing sealing failures in the sachet and leaking problems. On the other hand when particle size is too large then the rate of solubility is reduced thereby modifying an intended feature of the admixture product.

Use of non-soluble calcium salts such as calcium carbonate is more common in pre-mixed instant drink powders such as chocolate milk as these provide a much higher calcium content. The non-soluble nature of the calcium salt results in a non-clear appearance when added to clear water. This problem is obviated when used in non-clear beverages such as chocolate milk. Usage of non-soluble or slow-soluble calcium salt in transparent drinks (for example, in tea) will change the appearance of the product which may be a barrier for consumers.

New instant soluble calcium salts have been developed that contain a higher concentration of elemental calcium however these calcium salts also induce a specific recognizable taste that limits its use in products with high consumer sensitivity to taste profile such as sweeteners.

With these considerations in mind, it is desirable to have a food additive in the form of a sweetener admixed with a fast soluble calcium having the same look and feel as the sweetener without the disadvantages described. People who need to increase daily calcium consumption and have difficulty using supplement pills may find it easier to increase intake by using a product that is a mixture of soluble calcium salts with their preferred sweetener type. Such sweetener can be any caloric or non-caloric sweeteners.

### SUMMARY OF THE INVENTION

The present invention relates to nutraceutical compositions relating to a new and useful food and drink additive preparations in the form of sweeteners having soluble calcium admixtures.

A benefit of the present invention is it will provide a fortified sweetener having similar appearance, ease of use and taste when compared to preexisting sweeteners. In one embodiment, the present invention sweetener will contain approximately 150 mg of elemental calcium and 100 IU of vitamin D, which is equivalent to half a cup of milk. Thus, this will not change the familiar sweetener flavor while providing an easy way for Ca+D consumption while avoiding excessive intake thereof (e.g., 2500 mg upper tolerable limit). Therefore, such a sweetener can play an important role with subjects who may potentially fail to benefit from other approaches to calcium intake enhancement since it requires no lifestyle change or perception of taking “another pill”.

In addition, a marketing method may be used that promotes the known qualities of calcium not only for supporting bone health but also as a support for weight loss so that a combination of low calorie intense sweetener and calcium salts is presented as an enhanced product for achieving improved weight loss not only from the low caloric sweetening but also from the added calcium.

In one marketing method of a product employing the present invention, promotion would include the emphasis of the synergistic value of calcium and low-calorie sweetener for weight loss combined with an added value on bone health. And in yet another marketing method for a product employing the present invention, promotion would emphasize the synergistic value of calcium and low calorie sweetener to minimize risk of future fracture in which the value of calcium for bone health will be discussed as well as the correlation between lower body weight and the probability of fall and bone fracture.

### DETAILED DESCRIPTION OF THE INVENTION

A nutraceutical preparation is disclosed comprising combinations of calcium salts which vary in the degree and rate of soluble quality so that a desired balance between appearance, taste and calcium content may be achieved when used as an additive to cold or hot beverages.

It is to be appreciated that the below description sets forth two illustrative embodiments of the present invention regarding nutraceutical calcium salt combinations but the present invention is not be understood to be limited thereto.

A first embodiment of the present invention provides a high level of bioavailable calcium (50%-100% of recommended daily dose for an adult) with desirable taste and appearance characteristics given the amount of calcium content. A second embodiment of the present invention provides a desired taste and appearance using such combination of calcium salts to achieve the highest bio-available calcium content possible while also maintaining the desired taste, look and feel of the product (e.g., beverage clarity) it is employed with.

The preparation of a preferred embodiment makes use of calcium salts having different features such as solubility and elemental calcium content to optimize the product for each specific segment of consumers. Specifically, a mixture of calcium lactate gluconate with bulk density of approximately 600 Kg/m3 and calcium acetate with bulk density of approximately 300 Kg/m3 will be used to allow usage of significant quantities of such calcium salt having a calcium content of higher than 10%. At these bulk densities, the problem of “hovering” as previously discussed is significantly reduced or eliminated.

One embodiment, to be used for instance in products which clarity of the beverage is important, comprises 1-3% intense sweetener such sucralose, aspartame, saccharin or sucralose and 97-99% calcium salts combination.

In embodiments where more “natural” taste is desired, a percent of calcium may be replaced with dextrose, maltodextrin, soluble fibers or combinations of the above. In such embodiments, if the total amount of calcium is important then dextrose can be added (thereby increasing the total weight of each serving) without reducing the calcium amount. If the total weight of each serving is to be kept constant then the total calcium amount may be reduced for dextrose, maltodextrin, soluble fibers or combinations of the above. Such combination may contain calcium lactate gluconate (up to approximately 98%), calcium acetate (up to 98%) calcium citrate (up to approximately 98%), and calcium malate (up to approximately 98%), and up to approximately 400 IU vitamin D3.

Another embodiment of the invention, to be used for instance in products which clearness of the beverage is secondary or not important, comprises up to 3% intense sweetener such as sucralose, aspartame, saccharin, stevia, acessulfam-K, or sucralose and 97-99% calcium salts combination. Such combination can contain calcium lactate gluconate (up to approximately 98%), calcium acetate (up to approximately 98%), calcium citrate (up to approximately 98%), calcium malate (up to approximately 98%), calcium carbonate (up to approximately 98%), and up to 400 IU vitamin D3.

It is noted that calcium carbonate has a relatively high content of elementary calcium (40%), compared to about 20% or less in other calcium salts mentioned. However, calcium carbonate is an insoluble salt and therefore may create a “haze” when used in water based beverages and cannot be used when clarity is a required virtue of the beverage.

It is to be appreciated that when considering appearance the following factors are to be considered for marketing a table top product: 1) appearance (size, color, packaging) before use; and 2) appearance of the beverage (clarity, color) after mixing the product in it for a few seconds.

It is to be further appreciated that embodiments of the present invention optimize taste and appearance of a product it is employed with so that additives can be used that will reduce any after-taste of the product or improve the clear appearance of the final prepared beverage.

Additionally, further additional edible additives with known health benefits may be combined in the admixture in accordance with the present invention. Specifically one embodiment of the invention comprises a combination of an intense sweetener with a combination of calcium salts and vitamin D.

In yet other embodiments of the present invention, admixtures in accordance with the present invention would be packaged in packet packaging that is commonly used for table top sweeteners. In still other embodiments, the admixture would be packaged in table top dispensing devices.

In further embodiments of the present invention, the admixture is pre-portioned in approximately 1 g portions and in other embodiments the admixture is pre-portioned in up to approximately 3 g portions to achieve higher content of calcium and/or other vitamins.

In yet further embodiments, the admixture may componentized as two tablets (including pills or caplets or the like) wherein a first tablet consists of the sweetener and a second tablet is provided with nutritional supplements. In this embodiment, the admixture of the present invention may be created in situ (i.e., directly in the targeted food or beverage product) by adding one or more of each of the first and second tablets directly to the food or beverage product. In the componentized embodiment, users may increase sweetness at a fixed level of nutritional supplement or increase nutritional supplement at fixed sweetness level, thereby improving the user experience, without the need to manufacture different sweetener/nutritional supplement doses. Furthermore, the tablets may be dispensed conveniently via a tabletop dispenser, which may have two or more cartridges, one each for the sweetener tablets and nutritional supplement tablets, each of which may be dispensed, for example, by pressing corresponding buttons on the dispensing device.

In additional embodiments of the present invention, the admixture will appear as white powder and in other embodiment as one or more pills packaged together where as each pill in a plurality of pills may be a combined product or a separate content such as one or more sweetener pills and one or more vitamin pills.

In yet other embodiments of the present invention, the admixture may be packaged in a sealed, semipermeable or permeable membrane to deliver soluble calcium and/or artificial sweetener and/or other vitamins into a beverage in the same manner as a tea bag. In such embodiments, the permeability is sufficient so that the required food additives can pass into a beverage while retaining non-desirable components (e.g., tea leaves).

In other embodiments of the present invention, the admixture will be dispensed from a device for making hot or cold drinks so that a pre-defined or programmable amount of a food additive will be automatically added to the beverage made.

In additional embodiments the calcium salts will be mixed with sugar with or without intense sweeteners or may be mixed with brown sugar.

In still other embodiments of the present invention, mixtures of vitamins and soluble minerals are used to achieve optimal formulation for a specific health benefit. For example a mixture of soluble calcium, potassium and magnesium as well as vitamin D, vitamin K and vitamin C (do not need to be soluble due to very low quantities).

It is to be appreciated that the ratio of approximately 1.9:1 of calcium lactate gluconate to calcium acetate should be kept, including the possible range of 1:1 to 3:1 in some embodiments depending on the amount of sweetener used and other ingredients such as dextrose or sucrose (white or brown sugar). This rate provides an acceptable trade off between taste and calcium content.

The following are two preferred embodiment of a sweetener fortified with calcium and vitamin D.

Fortified Zero Calorie Sweetener

About 1 gr packet table top sweetener formulation—This embodiment allows for an elemental calcium content of 150 mg which is equivalent to half cup of milk with negligible change in taste:

| | |
|---|---|
| Suclarose | 13 mg or 1.3% (possible range 0.8%-1.5%) |
| Calcium lactate-gluconate | 64 mg or 64% (possible range 50-80%) |
| Calcium acetate | 35 mg or 35% (10%-40%) |
| Vitamin D3 | 100 iu (0 IU-800 IU) |

Fortified Sugar Preparation

Sugar packet formulation (the total serving size can change in the typical range of 4-7 g):

| | |
|---|---|
| Sugar (white/brown) | 3-5 g or 70% (±20%) based on a tea-spoon |
| | of sugar which is about 4 g but sometimes |
| | can be preferred as 3-5 g |
| Calcium lactate-gluconate | 19% or 760 mg to 1330 mg |
| Calcium acetate | 10% or 400 mg to 700 mg (the amount of |
| | total calcium salts can change from the |
| | preferred 29%) |
| Vitamin D3 | 100 iu (can range from 0 IU-800 IU) |

It is to be appreciated that some of the sugar content (up to 75%) can be replaced by one or a mixture of intense sweetener for reduced caloric content.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A nutraceutical admixture comprising calcium lactate gluconate, calcium acetate and a sweetener.

2. The nutraceutical admixture of claim 1 wherein the calcium lactate gluconate and the calcium acetate are mixed at a ratio of approximately 2:1.

3. The nutraceutical admixture of claim 1 wherein the calcium lactate gluconate has a bulk density of approximately 250 Kg/m³ and the calcium acetate has a bulk density of 650 Kg/m³.

4. The nutraceutical admixture of claim 1 wherein said sweetener is selected from the group consisting of sucralose, aspartame, saccharin and stevia and acesulfame K.

5. The nutraceutical admixture of claim 1 wherein said sweetener is equivalent to sugar having total weight at least twice that of said sweetener.

6. The nutraceutical admixture of claim 1 wherein said sweetener is brown sugar.

7. The nutraceutical admixture of claim 1 further including at least one nutritional supplement.

8. The nutraceutical admixture of claim 1 further including at least one additional mineral.

9. The nutraceutical admixture of claim 7 wherein said at least one nutritional supplement promotes bone health.

10. The nutraceutical admixture of claim 9 wherein said at least one nutritional supplement is selected from the group consisting of Vitamin D, Vitamin C and potassium.

11. The nutraceutical admixture of claim 1 wherein said calcium lactate gluconate has a bulk density of approximately 600 kg/m3.

12. The nutraceutical admixture of claim 11, wherein said calcium acetate has a bulk density of approximately 300 kg/m3.

13. A nutraceutical admixture comprising a sweetener and a calcium substitute selected from the group consisting of dextrose, maltodextrin and soluble fibers.

14. The nutraceutical admixture of claim 13, wherein said calcium substitute is a combination of dextrose, maltodextrin and soluble fibers.

15. The nutraceutical admixture of claim 13, wherein said sweetener is selected from the group consisting of sucralose, aspartame, saccharin and sucralose.

16. The nutraceutical admixture of claim 13, further including at least one vitamin is selected from the group consisting of Vitamin D, Vitamin C and potassium.

17. A nutraceutical admixture comprising a sweetener and calcium salts combination.

18. The nutraceutical admixture of claim 17, wherein said sweetener is selected from the group consisting of sucralose, aspartame, saccharin, stevia, acessulfam-k and stevia.

19. The nutraceutical admixture of claim 17, wherein said calcium salts is selected from the group consisting of calcium acetate, calcium citrate, calcium malate and calcium carbonate.

20. The nutraceutical admixture of claim 17 further including vitamin D3.
